(19) United States
(12) Patent Application Publication
(10) Pub. No.: US 2021/0109422 A1
(43) Pub. Date: Apr. 15, 2021

(54) BRACKET WITH ENHANCED HEAT DISSIPATION, LENS MODULE USING THE BRACKET, AND ELECTRONIC DEVICE USING THE LENS MODULE

(71) Applicant: TRIPLE WIN TECHNOLOGY(SHENZHEN) CO.LTD., Shenzhen (CN)

(72) Inventors: SHIN-WEN CHEN, Tu-Cheng (TW); LONG-FEI ZHANG, Shenzhen (CN); KUN LI, Shenzhen (CN); HAO-ZHONG LIU, Shenzhen (CN)

(21) Appl. No.: 16/691,805

(22) Filed: Nov. 22, 2019

(30) Foreign Application Priority Data
Oct. 12, 2019 (CN) 201921708927.5

(51) Int. Cl. G03B 17/55; G02B 7/02; G03B 17/12

(52) U.S. Cl. CPC G03B 17/55; G03B 17/12; G02B 7/028

(57) ABSTRACT

A bracket includes a first surface and a second surface opposite to the first surface. A first receiving groove is defined from the second surface to the first surface. At least one air escape hole defined from the first surface to the second surface. The air escape hole is connected to the first receiving groove. At least one sealing compound is filled in the air escape hole. An air escape passage is formed between the sealing compound and an inner wall of the air escape hole. The disclosure also relates to a camera module and an electronic device. The bracket can dissipate heat or moisture absorbed into the bracket and prevents dust and debris from entering into the interior of the camera module.

### FIELD

The subject matter of the application generally relates to a bracket, a lens module using the bracket, and an electronic device using the lens module.

### BACKGROUND

Electronic devices, such as mobile phones, tablet computers or cameras, may have lens modules. Most lens modules are composed of a lens, a holder, a motor, a filter, a sensor chip, a bracket, and a printed circuit board.

When the camera module is working in a high temperature or a high humidity environment, heat or moisture may enter an interior of the camera module. The heat and the moisture condense on the filter into droplets, which affect an image quality of the lens module.

### BRIEF DESCRIPTION OF THE DRAWINGS

Implementations of the present disclosure will now be described, by way of embodiments, with reference to the attached figures.

FIG. 1 is a perspective view of a first embodiment of a bracket according to the present disclosure.

FIG. 2 is an exploded view of the bracket of FIG. 1.

FIG. 3 is a cross-section view of the bracket along line of FIG. 1.

FIG. 4 is a cross-section view of the bracket along line IV-IV of FIG. 1.

FIG. 5 is a cross-section view of a first embodiment of a lens module according to the present disclosure.

FIG. 6 is a perspective view of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

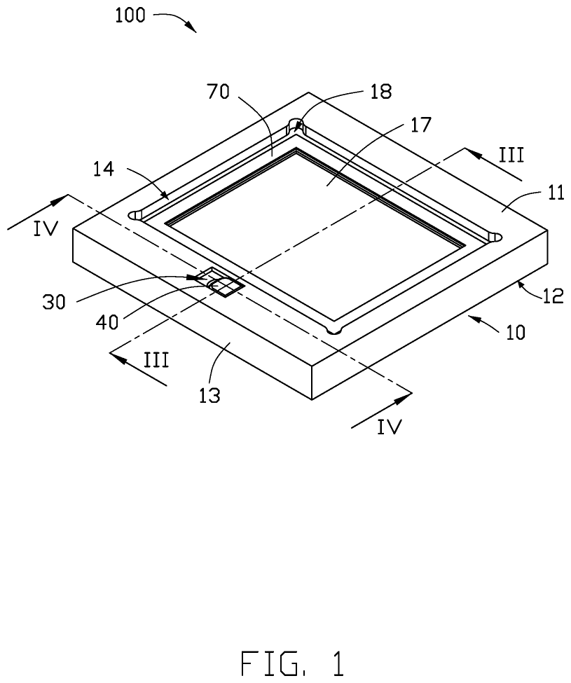

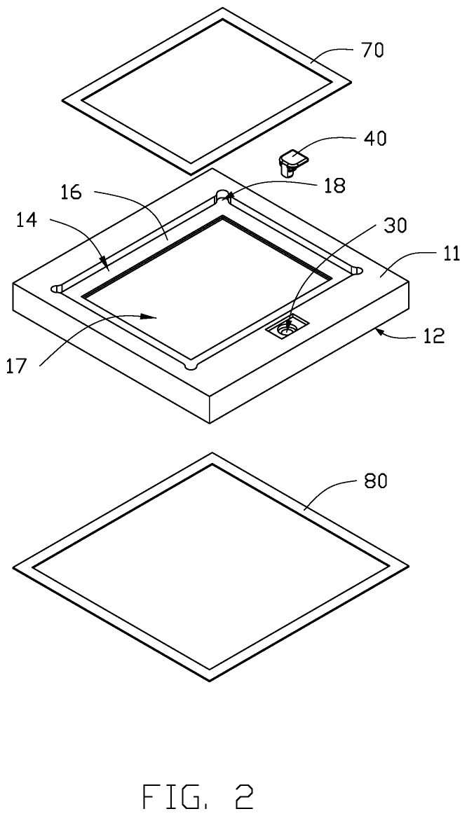

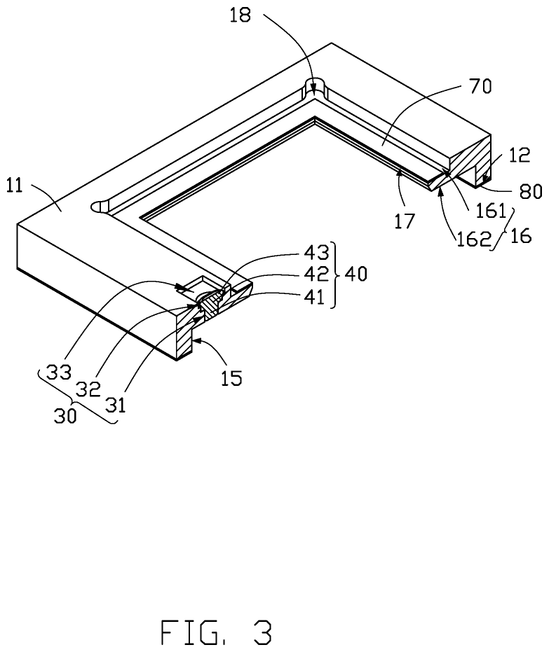

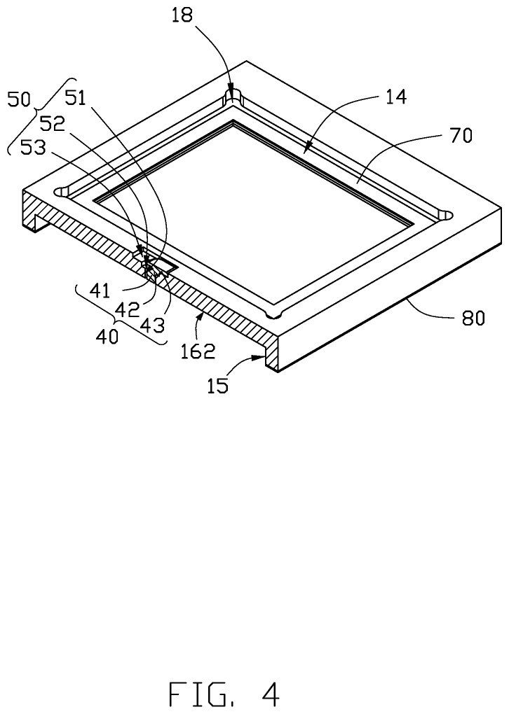

FIGS. 1-4 show an embodiment of a bracket 100. The bracket 100 includes a main body 10 and at least one sealing compound 40. The main body 10 includes a first surface 11, a second surface 12, and a plurality of side surfaces 13. The second surface 12 is opposite to the first surface 11. The plurality of side surfaces 13 is connected to the first surface 11 and the second surface 12. In at least one embodiment, the main body 10 includes four side surfaces 13. The four side surfaces 13 are connected to each other end to end.

A second receiving groove 14 is defined in the main body 10 from the first surface 11 to the second surface 12. The second receiving groove 14 is used to receive a filter.

A first receiving groove 15 is defined in the main body 10 from the second surface 12 to the first surface 11. The first receiving groove 15 is used to receive a sensor.

The main body 10 further includes a supporting portion 16. The supporting portion 16 is located between the second receiving groove 14 and the first receiving groove 15. The supporting portion 16 is used to support a filter. The supporting portion 16 separates the second receiving groove 14 and the first receiving groove 15. That is, the supporting portion 16 can be regard as bottoms of the second receiving groove 14 and the first receiving groove 15.

A through hole 17 is defined in the supporting portion 16. The second receiving groove 14 is connected to the first receiving groove 15 by the through hole 17.

A plurality of third receiving grooves 18 is defined in the main body 10 from the first surface 11 to the second surface 12. The plurality of third receiving grooves 18 is located at corners of the second receiving groove 14 and is connected to the second receiving groove 14. The plurality of third receiving grooves 18 is used to receive excessive glue.

In at least one embodiment, the bracket 100 is made of an insulating plastic or a conductive metal. The insulating plastic is selected from at least one of polyester, epoxy, polyurethane, polybutadiene acid, silicone, polyester imide and polyamide. The conductive metal is selected from a group consisting of copper, aluminum, iron, gold, and alloys.

In other embodiments, the bracket 100 may also be a combination of an insulating plastic and a conductive metal, for example, a conductive metal layer is formed on the insulating plastic by an injection molding process.

At least one air escape hole 30 is defined in the main body 10 and extending from the first surface 11 to the second surface 12. The air escape hole 30 is connected to the first receiving groove 15. The air escape hole 30 is used to dissipate heat generated during a roasting process.

The sealing compound 40 is filled in the air escape hole 30. The sealing compound 40 does not completely cover the air escape hole 30.

An air escape passage 50 is formed between the sealing compound 40 and an inner wall of the air escape hole 30. The air escape passage 50 is used to dissipate heat or moisture absorbed into the first receiving groove 15 and prevents dust and debris from entering into the interior of the camera module 100.

In at least one embodiment, the air escape hole 30 includes a first hole portion 31, a second hole portion 32, and a third hole portion 33. The first hole portion 31 is connected to the second hole portion 32. The second hole portion 32 is connected to third hole portion 33. The air escape hole is a stepped hole. Inner diameters of the first hole portion 31, the second hole portion 32, and the third hole portion 33 are gradually increased. The first hole portion 31 is connected to the first receiving groove 15.

In other embodiment, the second hole portion 32 and/or the third hole portion 33 can be omitted.

In at least one embodiment, the sealing compound 40 includes a first sealing portion 41, a second sealing portion 42, and a third sealing portion 43. The first sealing portion 41 is connected to the second sealing portion 42. The second sealing portion 42 is connected to third sealing portion 43. The first sealing portion 41, the second sealing portion 42, and the third sealing portion 43 are formed in a form of a ladder. External diameters of the first sealing portion 41, the second sealing portion 42, and the third sealing portion 43 are gradually increased. The first sealing portion 41 is received in the first hole portion 31. The second sealing portion 42 is received in the second hole portion 32. The third sealing portion 43 is received in the third hole portion 33.

The second hole portion 32 and/or the third hole portion 33 can increase contacting area between the sealing compound 40 and the air escape hole 30, thereby enhancing a binding force between the sealing compound 40 and the air escape hole 30.

An exposed surface of the third sealing portion 43 away from the second sealing portion 42 is flush with the first surface 11 to make the bracket 100 have a better appearance.

In other embodiment, the second sealing portion 42 and/or the third sealing portion 43 can be omitted.

In at least one embodiment, the first sealing portion 41, the second sealing portion 42, and the third sealing portion 43 are integrally formed.

In at least one embodiment, the sealing compound 40 is a colloid. The colloid can be selected from at least one of polyester, epoxy, polyurethane, polybutadiene acid, silicone, polyester imide, and polyimide.

In at least one embodiment, the air escape passage 50 includes a first gap 51, a second gap 52, and a third gap 53. The first gap 51 is defined by the first hole portion 31 and an inner wall of the first sealing portion 41. The second gap 52 is defined by the second hole portion 32 and an inner wall of the second sealing portion 42. The third gap 53 is defined by the third hole portion 33 and an inner wall of the third sealing portion 43.

In other embodiment, the second gap 52 and/or the third gap 53 can be omitted.

The bracket 100 further includes a first adhesive layer 70. The first adhesive layer 70 is formed on the supporting portion 16 and is used to fix the filter on the supporting portion 16.

The bracket 100 further includes a second adhesive layer 80. The second adhesive layer 80 is formed on the second surface 12 and used to fix the bracket 100 on a printed circuit board.

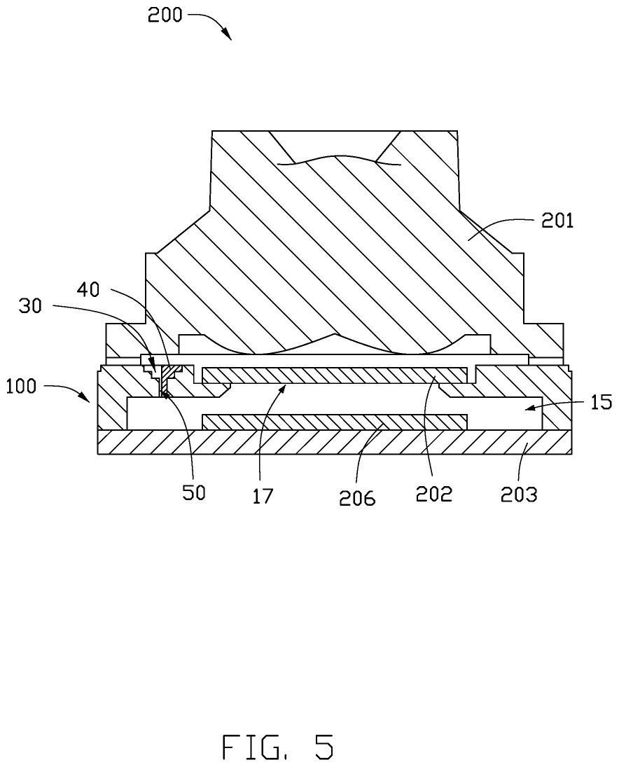

FIG. 5 shows an embodiment of a camera module 200. The lens 201 can be a zoom lens or a prime lens.

In at least one embodiment, the camera module 200 is a prime lens. The camera module 200 includes the bracket 100. The camera module 200 further includes a lens 201, a filter 202, a printed circuit board 203, and a sensor 206. The lens 201 is mounted on the bracket 100. The bracket 100 is mounted on the printed circuit board 203 by the second adhesive layer 80. The filter 202 is fixed on the supporting portion 16 by the first adhesive layer 70. The filter 202 faces the through hole 17 and the lens 201. The sensor 206 is mounted on the printed circuit board 203, electrically connected to the printed circuit board 203, and received in the first receiving groove 15. The sensor 206 faces the through hole 17.

The lens 201 is used to converge lights. The filter 202 is used to filter stay light of the lights from the lens 201. The sensor 206 is used to convert the lights from the filter 202 into image.

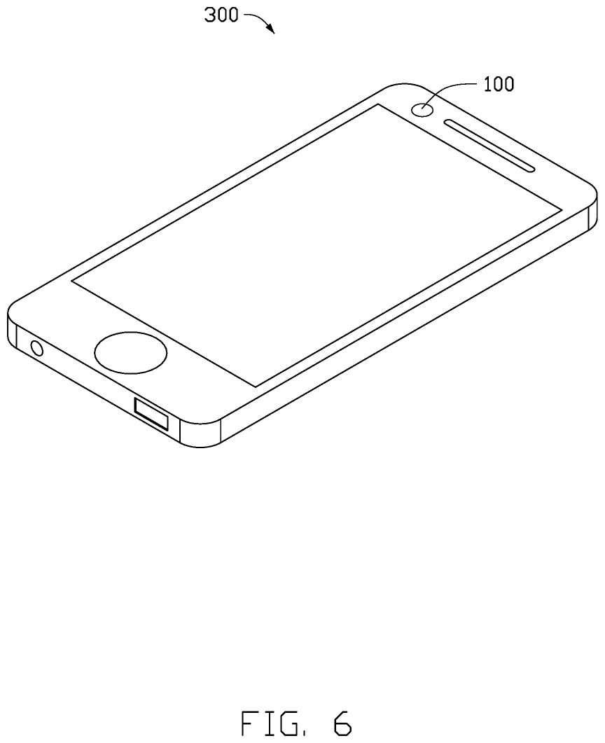

FIG. 6 shows an embodiment of an electronic device 300. The electronic device 300 includes the camera module 200. The electronic device 300 may be a smart phone, a tablet computer, or the like. In at least one embodiment, the electronic device 300 is a smart phone.

With the embodiments described above, at least one air escape hole 30 is defined in the bracket 100, at least one sealing compound 40 is filled in the air escape hole 30, but does not completely cover the air escape hole 30. An air escape passage 50 is formed between the sealing compound 40 and the air escape hole 30. The air escape passage 50 can dissipate heat or moisture absorbed into the bracket 100 and prevents dust and debris from entering into the interior of the camera module 100.

The embodiments shown and described above are only examples. Many details are often found in the art such as the other features of a bracket, a lens module using the bracket, and an electronic device using the lens module. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A bracket comprising:
a first surface;
a second surface opposite to the first surface; wherein a first receiving groove is defined from the second surface to the first surface;
at least one air escape hole extending from the first surface to the second surface, wherein the air escape hole is connected to the first receiving groove; and
at least one sealing compound filled in the air escape hole; wherein an air escape passage is formed between the sealing compound and an inner wall of the air escape hole.

2. The bracket of claim 1, wherein the air escape hole comprises a first hole portion connected to the first receiving groove; the sealing compound comprises a first sealing portion; the air escape passage comprises a first gap; the first sealing portion is filled in the first hole portion; and the first gap is defined between the first hole portion and the first sealing portion.

3. The bracket of claim 2, wherein the air escape hole further comprises a second hole portion connected to the first hole portion; the sealing compound further comprises a second sealing portion connected to the first sealing portion; the air escape passage further comprises a second gap connected to the first gap; the second sealing portion is filled in the second hole portion; and the second gap is defined between the second hole portion and the second sealing portion.

4. The bracket of claim 3, wherein the air escape hole further comprises a third hole portion connected to the second hole portion; the sealing compound further comprises a third sealing portion connected to the second sealing portion; the air escape passage further comprises a third gap connected to the second gap; the third sealing portion is filled in the third hole portion; and the third gap is defined between the third hole portion and the third sealing portion.

5. The bracket of claim 4, wherein the air escape hole is a stepped hole.

6. The bracket of claim 4, wherein an exposed surface of the third sealing portion away from the second sealing portion is flush with the first surface.

7. The bracket of claim 1, wherein a second receiving groove is defined from the first surface to the second surface; the second receiving groove is connected to the first receiving groove by a through hole; the bracket further comprises a supporting portion located between the second receiving groove and the first receiving groove; the through hole is defined in the supporting portion.

8. The bracket of claim 7, wherein a plurality of third receiving grooves is defined from the first surface to the second surface; the plurality of third receiving grooves are located at corners of the second receiving groove and connected to the second receiving groove; and the plurality of third receiving grooves receive excessive glue.

9. A camera module comprising:
a bracket, wherein the bracket comprises:
a first surface;
a second surface opposite to the first surface; wherein a first receiving groove is defined from the second surface to the first surface;
at least one air escape hole defined from the first surface to the second surface,
wherein the at least one air escape hole is connected to the first receiving groove; and
at least one sealing compound filled in each of the at least one air escape hole;
wherein an air escape passage is formed between the sealing compound and an inner wall of each of the at least one air escape hole; and
a printed circuit board mounted on the printed circuit board; and
a sensor mounted on the printed circuit board, electrically connected to the printed circuit board, and received in the first receiving groove.

10. The camera module of claim 9, wherein each of the at least one air escape hole comprises a first hole portion connected to the first receiving groove; the sealing compound comprises a first sealing portion; the air escape passage comprises a first gap; the first sealing portion is filled in the first hole portion; and the first gap is defined between the first hole portion and the first sealing portion.

11. The camera module of claim 10, wherein each of the at least one air escape hole further comprises a second hole portion connected to the first hole portion; the sealing compound further comprises a second sealing portion connected to the first sealing portion; the air escape passage further comprises a second gap connected to the first gap; the second sealing portion is filled in the second hole portion; and the second gap is defined between the second hole portion and the second sealing portion.

12. The camera module of claim 11, wherein each of the at least one air escape hole further comprises a third hole portion connected to the second hole portion; the sealing compound further comprises a third sealing portion connected to the second sealing portion; the air escape passage further comprises a third gap connected to the second gap; the third sealing portion is filled in the third hole portion; and the third gap is defined between the third hole portion and the third sealing portion.

13. The camera module of claim 12, wherein the air escape hole is a stepped hole.

14. The camera module of claim 12, wherein an exposed surface of the third sealing portion away from the second sealing portion is flush with the first surface.

15. The camera module of claim 9, wherein the camera module further comprises a filter; a second receiving groove is defined from the first surface to the second surface; the second receiving groove is connected to the first receiving groove by a through hole; the bracket further comprises a supporting portion located between the second receiving groove and the first receiving groove; the through hole is defined in the supporting portion; and the filter is received in the second receiving groove and mounted on the supporting portion.

16. The camera module of claim 15, wherein a plurality of third receiving grooves are defined from the first surface to the second surface; the plurality of third receiving grooves are located at corners of the second receiving groove and connected to the second receiving groove; and the plurality of third receiving grooves receive excessive glue.

17. An electronic device comprising:
a camera module; the camera module comprising:
a bracket, wherein the bracket comprises:
a first surface;
a second surface opposite to the first surface; wherein a first receiving groove is defined from the second surface to the first surface;
at least one air escape hole defined from the first surface to the second surface, wherein each of the at least one air escape hole is connected to the first receiving groove; and
at least one sealing compound filled in each of the at least one air escape hole; wherein an air escape passage is formed between the sealing compound and an inner wall of each of the at least one air escape hole; and
a printed circuit board, wherein the bracket is mounted on the printed circuit board; and
a sensor mounted on the printed circuit board, electrically connected to the printed circuit board, and received in the first receiving groove.

18. The electronic device of claim 17, wherein each of the at least one air escape hole comprises a first hole portion connected to the first receiving groove; the sealing compound comprises a first sealing portion; the air escape passage comprises a first gap; the first sealing portion is filled in the first hole portion; and the first gap is defined between the first hole portion and the first sealing portion.

19. The electronic device of claim 18, wherein each of the at least one air escape hole further comprises a second hole portion connected to the first hole portion; the sealing compound further comprises a second sealing portion connected to the first sealing portion; the air escape passage further comprises a second gap connected to the first gap; the second sealing portion is filled in the second hole portion; and the second gap is defined between the second hole portion and the second sealing portion.

20. The electronic device of claim 19, wherein each of the at least one air escape hole further comprises a third hole portion connected to the second hole portion; the sealing compound further comprises a third sealing portion connected to the second sealing portion; the air escape passage further comprises a third gap connected to the second gap; the third sealing portion is filled in the third hole portion; and the third gap is defined between the third hole portion and the third sealing portion.
